(19) United States
(12) Patent Application Publication
(10) Pub. No.: US 2014/0290918 A1
(43) Pub. Date: Oct. 2, 2014

(54) HEAT DISSIPATION MODULE AND CENTRIFUGAL FAN THEREOF

(71) Applicant: Quanta Computer, Inc, Taoyuan Shien (TW)

(72) Inventor: Ching-Yu CHEN, Taoyuan Shien (TW)

(21) Appl. No.: 13/914,496

(22) Filed: Jun. 10, 2013

(30) Foreign Application Priority Data
Apr. 2, 2013 (TW) 102111916

(51) Int. Cl. G06F 1/20; F28D 15/02

(52) U.S. Cl. CPC G06F 1/203; F28D 15/02
USPC 165/121; 165/104.26

(57) ABSTRACT

A heat dissipation module includes a centrifugal fan, a second heat dissipation fin array, and a heat pipe. The centrifugal fan includes an outer housing, a first heat dissipation fin array, an impeller and a rotation-driving device. The outer housing has an axial air inlet and a radial air outlet. The rotation-driving device is located within the outer housing and used to drive the impeller to rotate. The second heat dissipation fin array is attached to the radial air outlet. An end of the heat pipe is in contact with both the second heat dissipation fin array and a flat wall of the outer housing on which the axial air inlet is located.

### CROSS-REFERENCE TO RELATED APPLICATIONS

This application claims priority to Taiwan Application Serial Number 102111916, filed Apr. 2, 2013, which is herein incorporated by reference.

### FIELD OF THE INVENTION

The present invention relates to a heat dissipation module. More particularly, the present invention relates to a heat dissipation module equipped with a centrifugal fan.

### BACKGROUND

A heat dissipation module equipped with a centrifugal fan is used in most notebook computers as their system coolers. The heat dissipation module includes a centrifugal fan, a heat pipe and a heat dissipation fin array. A first end of the heat pipe is in contact with a heat source, e.g., a CPU, while a second opposite end of the heat pipe is connected with the heat dissipation fin array, thereby transferring heat from the heat source to the heat dissipation fin array. The heat dissipation fin array is fastened to an air outlet of the centrifugal fan. When an impeller of the centrifugal fan rotates, airflows carry the heat on the heat dissipation fin array out of the notebook computer.

However, the notebook computers are designed to be thin and compact, the dissipation modules inside them are also designed to be thinner. Similarly, the heat dissipation fin array attached to an air outlet of the centrifugal fan is also reduced in its thickness such that a total cooling area of the heat dissipation fin array is reduced to affect the heat dissipation performance to a certain extent. If the fan speed of the centrifugal fan is accelerated to compensate the thermal performance, unwanted noises are also introduced. For the forgoing reasons, there is a need for dealing the heat dissipation efficiency issue due to the thinner notebook computer design.

### SUMMARY

It is therefore an objective of the present invention to provide an improved heat dissipation module equipped with a centrifugal fan.

In accordance with the foregoing and other objectives of the present invention, a heat dissipation module includes a centrifugal fan, a second heat dissipation fin array, and a heat pipe. The centrifugal fan includes an outer housing, a first heat dissipation fin array, an impeller and a rotation-driving device. The outer housing has an axial air inlet and a radial air outlet. The impeller is located within the outer housing. The rotation-driving device is located within the outer housing and used to drive the impeller to rotate. The second heat dissipation fin array is attached to the radial air outlet. An end of the heat pipe is in contact with both the second heat dissipation fin array and a flat wall of the outer housing on which the axial air inlet is located.

In accordance with the foregoing and other objectives of the present invention, a centrifugal fan includes an outer housing, a first heat dissipation fin array, an impeller and a rotation-driving device. The outer housing has an axial air inlet and a radial air outlet. The impeller is located within the outer housing. The rotation-driving device is located within the outer housing and used to drive the impeller to rotate.

According to another embodiment disclosed herein, the flat wall of the outer housing, on which the axial air inlet is located, is a metallic wall.

According to another embodiment disclosed herein, the impeller includes a central hub, a plurality of connection members and a plurality of wind-driving members. The connection members extend radially and outwardly from the central hub. The wind-driving members extending radially and outwardly from the central hub from each connection member respectively, wherein each wind-driving member is greater than each connection member in respective vertical heights. The central hub, the connection members and the wind-driving members collectively form a virtual annular recess when the impeller rotates.

According to another embodiment disclosed herein, the first heat dissipation fin array is disposed within the virtual annular recess, and not interfered with the central hub, the connection members and the wind-driving members when the impeller rotates.

According to another embodiment disclosed herein, each fin of the first heat dissipation fin array is an arc-shaped fin.

Thus, the heat dissipation module is equipped with an additional first heat dissipation fin array around an axial air inlet of its centrifugal fan so as to increase the overall surface area and enhance the thermal performance. In addition, the heat pipe is in contact with both the second heat dissipation fin and the top wall of the centrifugal fan's outer housing such that the top wall can rapidly transfer heat from the heat pipe to the first heat dissipation fin array. Furthermore, because the impeller have different vertical heights in its different parts, the central hub, the connection members and the wind-driving members collectively form a virtual annular recess when the impeller rotates. Therefore, the first heat dissipation fin array can be located within the virtual annular recess, and not interfered with the impeller.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a perspective view of a heat dissipation module equipped with a centrifugal fan according to an embodiment of this invention;

FIG. 2 illustrates a cross-sectional view taken along the line 2-2′ of the heat dissipation module in FIG. 1;

FIG. 3 illustrates a perspective view of an impeller of the centrifugal fan in FIG. 2; and

FIG. 4 illustrates a top view of the centrifugal fan in FIG. 1 with a top wall removed.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to address the impact of the thermal performance of a conventional cooling module thickness reduction, the present invention proposes a new centrifugal fan, its outer housing is equipped with a heat dissipation fin array around the axial air inlet. The additional heat dissipation fin array works with the original heat dissipation fin array, so as to increase the overall cooling surface area of the cooling module and enhance the thermal performance.

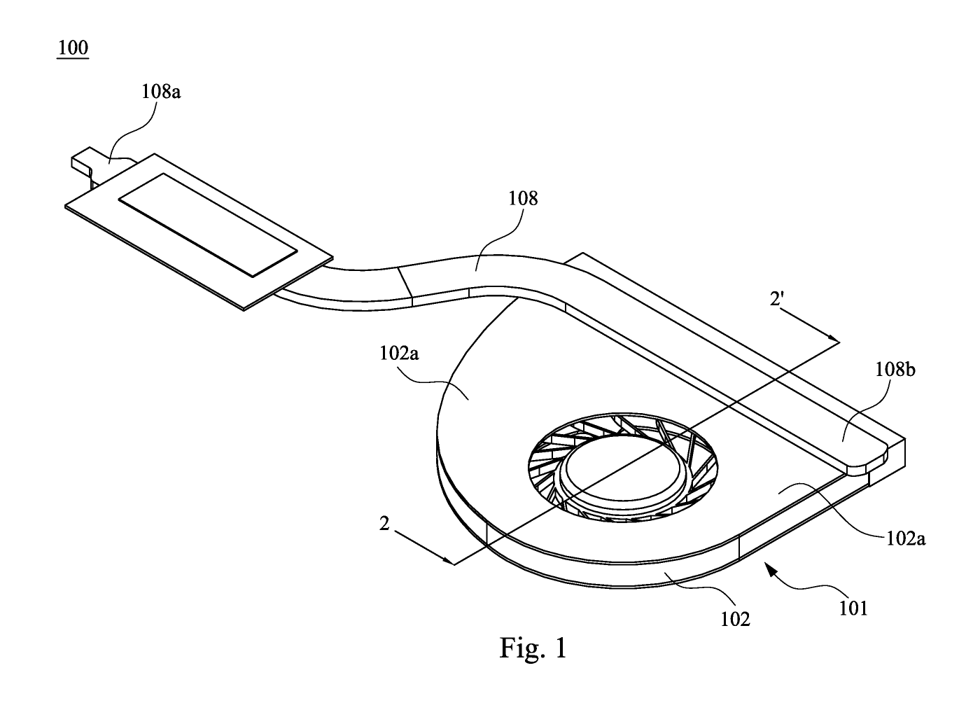

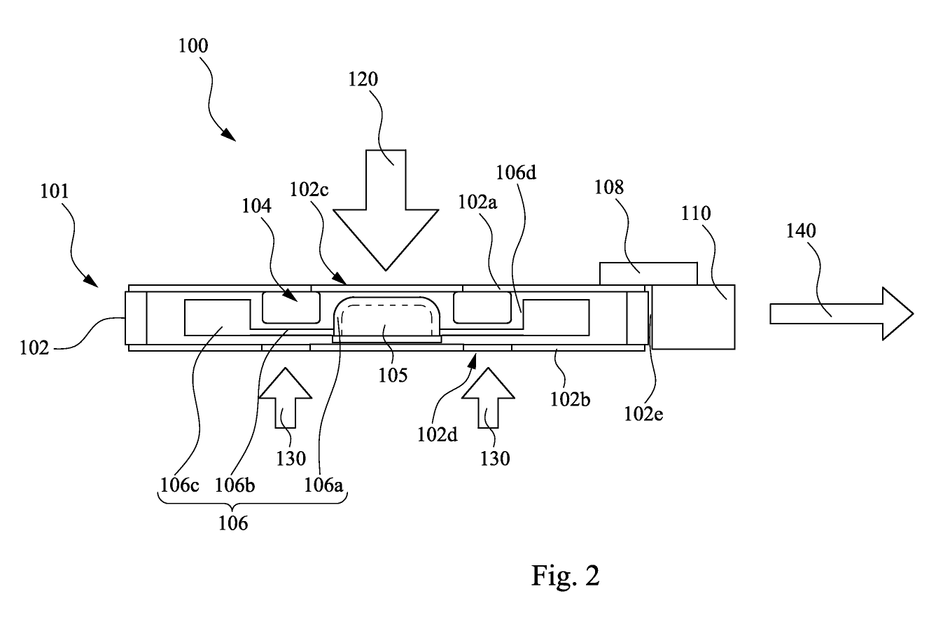

FIG. 1 illustrates a perspective view of a heat dissipation module equipped with a centrifugal fan according to an embodiment of this invention. A heat dissipation module 100 includes a centrifugal fan 101, a second heat dissipation fin array 110 (referring to FIG. 2) and a heat pipe 108. The heat pipe 108 has an end 108a in contact with a heat generating source (e.g., a CPU) and an opposite end 108b connected with the centrifugal fan 101 and the second heat dissipation fin array 110 so as to rapidly transfer heat from the heat generating source to the later two. Compared with a conventional heat dissipation module, the end 108b of the heat pipe 108 is in contact with both the second heat dissipation fin array 110 and a top wall 102a of the centrifugal fan's outer housing 102. The centrifugal fan 101 is also equipped with additional heat dissipation designs that are detailed below.

FIG. 2 illustrates a cross-sectional view taken along the line 2-2′ of the heat dissipation module in FIG. 1. The outer housing 102 of the centrifugal fan 101 is equipped with at least an axial air inlet (102c or 102d) and a radial air outlet 102e. In this embodiment, the centrifugal fan 101 has a first heat dissipation fin array 104, which is located circularly around the axial air inlet 102c and at inner walls of the outer housing 102. In addition, a second heat dissipation fin array 110 is located at the radial air outlet 102e of the outer housing 102. Therefore, the first heat dissipation fin array 104 and the second heat dissipation fin array 110 collectively increase the total heat dissipation surface area for the heat dissipation module. Material of the first heat dissipation fin array 104 is substantially the same as the material of the second heat dissipation fin array 110. The material used in heat dissipation fin arrays can be copper, aluminum or alloys thereof. The heat dissipation fin arrays may be manufactured by a precision die-casting, CNC machining or metal stamping, etc., and then soldered to an inner wall of the top wall 102a of the outer housing 102.

When a rotation-driving device 105 (which is secured to a bottom wall 102b) within the outer housing 102 drives the impeller 106 to rotate, airflows are introduced into the outer housing 102 via the axial air inlet 102c along a direction 120 or via the axial air inlet 102d along a direction 130, and output via the radial air outlet 102e along a direction 140. Therefore, airflows introduced via the axial air inlet 102c would pass by the first heat dissipation fin array 104 and airflows output via the radial air outlet 102e would pass by the second heat dissipation fin array 110 such that heat transferred to the first, second heat dissipation fin arrays can be taken away.

It is noted that the first heat dissipation fin array 104 can effectively dissipate heat when the flat wall (i.e., the top wall 102a) of the outer housing 102, on which the axial air inlet 102c is located, is a wall of better thermal conductivity. In this embodiment, the top wall 102a is, but not being limited to, a metallic wall.

Moreover, in order to effectively enhance a thermal performance of the first heat dissipation fin array 104, the heat pipe 108 is preferably in contact with both the second heat dissipation fin array 110 and the top wall 102a of the centrifugal fan's outer housing 102 such that the top wall 102a can rapidly transfer heat from the heat pipe 108 to the first heat dissipation fin array 104. If the heat pipe 108 is in contact with the second heat dissipation fin array 110 only, little heat can be transferred from the second heat dissipation fin array 110 to the top wall 102a due to poor thermal connection (i.e., a small connection area), which results in a waste of the first heat dissipation fin array 104.

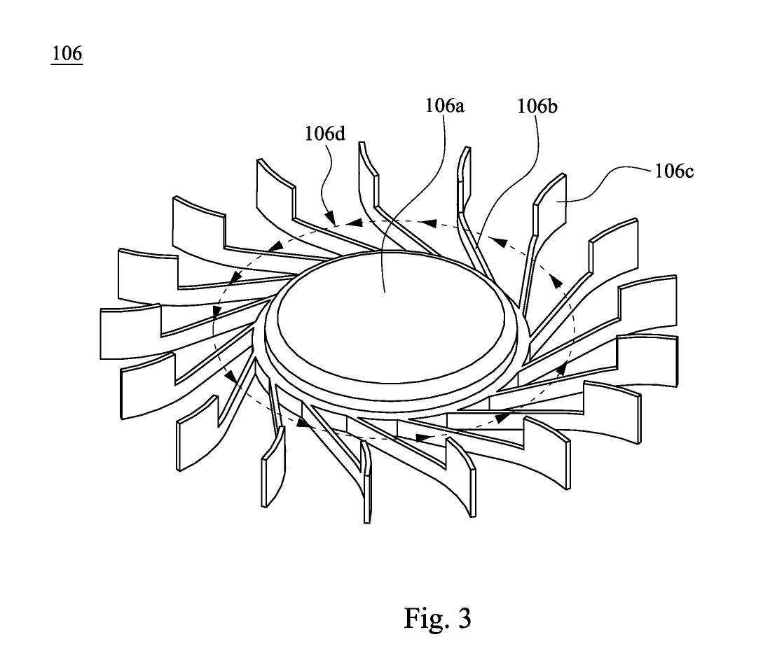

Referring to FIGS. 2 and 3, FIG. 3 illustrates a perspective view of an impeller in FIG. 2. In order to layout a space within the outer housing 102 of the centrifugal fan 101 to accommodate the first heat dissipation fin array 104, the impeller 106 is modified like a Ferris wheel. The impeller 106 includes a central hub 106a, a plurality of connection members 106b and a plurality of wind-driving members 106c. The connection members 106b extend radially and outwardly from the central hub 106a, and the wind-driving members 106c extend radially and outwardly from each connection member 106b respectively. Each wind-driving member 106c is greater than each connection member 106b in respective vertical heights such that the wind-driving member 106c serve as a major part to drive the airflows. Because the central hub 106a, the connection members 106b and the wind-driving members 106c have different vertical heights, i.e., the connection members 106b is smaller than the central hub 106a and the wind-driving members 106c in vertical heights, the central hub 106a, the connection members 106b and the wind-driving members 106c collectively form a virtual annular recess 106d when the impeller 106 rotates. Therefore, the first heat dissipation fin array 104 can be located within the virtual annular recess 106d, and not interfered with the central hub 106a, the connection members 106b and the wind-driving members 106c when the impeller 106 rotates. In this embodiment, the impeller 106 can be manufactured by precision plastic injection, which is similar to the current centrifugal fan blade manufacturing method.

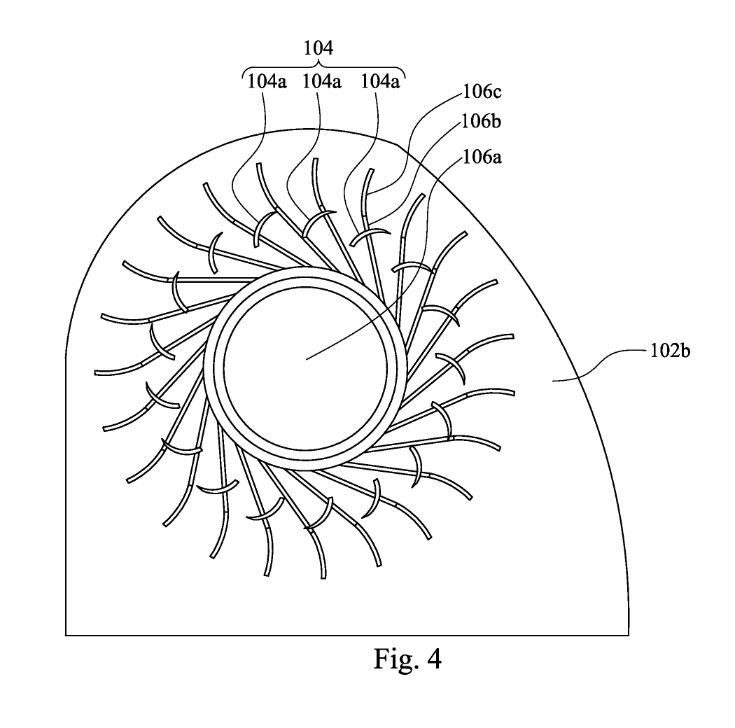

FIG. 4 illustrates a top view of the centrifugal fan in FIG. 1 with a top wall removed. It is noted that each fin 104a of the first heat dissipation fin array 104 is secured to the top wall of the centrifugal fan's outer housing. For clarity, the top wall is removed to show the first heat dissipation fin array 104 located below. In this embodiment, each fin 104a of the first heat dissipation fin array 104 is an arc-shaped fin (or wing-shaped fin), which is radially arranged within the centrifugal fan, but not being limited to. In addition, when each fin 104a of the first heat dissipation fin array 104 crosses either one of the connection members 106, these two are nearly orthogonal to each other. With such design, the airflows generated by the impeller 106 make fewer noises when they pass by each fin 104a of the first heat dissipation fin array 104, but the present invention is not limited to such design. Furthermore, in order to introduce enough airflows into the centrifugal fan, a pitch between adjacent fins 104a of the first heat dissipation fin array 104 is greater than a pitch between adjacent fins of the second heat dissipation fin array 110, but not being limited to such relationship.

According to above-discussed embodiments, the heat dissipation module is equipped with an additional first heat dissipation fin array around an axial air inlet of its centrifugal fan so as to increase the overall surface area and enhance the thermal performance. In addition, the heat pipe is in contact with both the second heat dissipation fin and the top wall of the centrifugal fan's outer housing such that the top wall can rapidly transfer heat from the heat pipe to the first heat dissipation fin array. Furthermore, because the impeller has different vertical heights in its different parts, the central hub, the connection members and the wind-driving members collectively form a virtual annular recess when the impeller rotates. Therefore, the first heat dissipation fin array can be located within the virtual annular recess, and not interfered with the impeller.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A heat dissipation module comprising:
a centrifugal fan comprising:
an outer housing including an axial air inlet and a radial air outlet;
a first heat dissipation fin array is disposed circularly around the axial air inlet and at inner walls of the outer housing;
an impeller disposed within the outer housing; and
a rotation-driving device disposed within the outer housing to drive the impeller to rotate;
a second heat dissipation fin array disposed at the radial air outlet; and
a heat pipe having an end in contact with both the second heat dissipation fin array and a flat wall of the outer housing on which the axial air inlet is located.

2. The heat dissipation module of claim 1, wherein the flat wall of the outer housing, on which the axial air inlet is located, is a metallic wall.

3. The heat dissipation module of claim 1, wherein the impeller comprising:
a central hub;
a plurality of connection members extending radially and outwardly from the central hub; and
a plurality of wind-driving members extending radially and outwardly from the central hub from each connection member respectively, wherein each wind-driving member is greater than each connection member in respective vertical heights, the central hub, the connection members and the wind-driving members collectively form a virtual annular recess when the impeller rotates.

4. The heat dissipation module of claim 3, wherein the first heat dissipation fin array is disposed within the virtual annular recess, and not interfered with the central hub, the connection members and the wind-driving members when the impeller rotates.

5. The heat dissipation module of claim 1, wherein each fin of the first heat dissipation fin array is an arc-shaped fin.

6. A centrifugal fan comprising:
an outer housing including an axial air inlet and a radial air outlet;
a first heat dissipation fin array is disposed circularly around the axial air inlet and at inner walls of the outer housing;
an impeller disposed within the outer housing; and
a rotation-driving device disposed within the outer housing to drive the impeller to rotate.

7. The centrifugal fan of claim 6, wherein a flat wall of the outer housing, on which the axial air inlet is located, is a metallic wall.

8. The centrifugal fan of claim 6, wherein the impeller comprising:
a central hub;
a plurality of connection members extending radially and outwardly from the central hub; and
a plurality of wind-driving members extending radially and outwardly from the central hub from each connection member respectively, wherein each wind-driving member is greater than each connection member in respective vertical heights, the central hub, the connection members and the wind-driving members collectively form a virtual annular recess when the impeller rotates.

9. The centrifugal fan of claim 8, wherein the first heat dissipation fin array is disposed within the virtual annular recess, and not interfered with the central hub, the connection members and the wind-driving members when the impeller rotates.

10. The centrifugal fan of claim 6, wherein each fin of the first heat dissipation fin array is an arc-shaped fin.
